(19) United States
(12) Patent Application Publication
(10) Pub. No.: US 2008/0192213 A1
(43) Pub. Date: Aug. 14, 2008

(54) APPARATUS, SYSTEM, AND METHOD FOR MOUNTING AND POSITIONING AN OPTICAL PROJECTOR

(76) Inventors: Glenn M. Johnson, Salt lake City, UT (US); Ed Heater, Eden, UT (US); Troy Seaton, West Jordan, UT (US)

Correspondence Address: Kunzler & McKenzie, 8 EAST BROADWAY, SUITE 600, SALT LAKE CITY, UT, 84111, US

(21) Appl. No.: 11/672,892

(22) Filed: Feb. 8, 2007

(51) Int. Cl. G03B 21/22

(52) U.S. Cl. 353/119

(57) ABSTRACT

An apparatus, system, and method are disclosed for mounting and positioning an optical projector. First and second base members are aligned in parallel rows. A first upright arm extends from the first base member and is moveably secured such that the first upright arm is moveable relative to the first base member. A second upright arm opposed to the first upright arm, extends from the second base member and is moveably secured such that the second upright arm is moveable relative to the second base member. A cross member extends between the first and second upright arms and is moveably secured such that it is moveable relative to the first upright arm and the second upright arm. A mounting bracket is configured to attach to an optical projector and is moveably secured to the cross member such that the mounting bracket is moveable relative to the cross member.

### BACKGROUND OF THE INVENTION

1. Field of the Invention

This invention relates to optical projectors and more particularly, to a mounting system for multi-directional rotation and fine position adjustment of a framing projector.

2. Description of the Related Art

Opto-mechanical devices such as framing projectors and stage lighting require a mounting apparatus as well as a mechanism that permits a user to accurately position the device such that light is received from or projected onto a desired object, such as a painting, sculpture, other work of art, display screen, wall, or theatrical stage. Typical framing projector mounting systems allow a user to roughly align the projector with the target using a gimbal that includes a ball and socket that allows for movement in three axes simultaneously.

It is well known in the art for optical projectors such as framing projectors to be mounted in a housing and positioned using a gimbal having three pivot axes corresponding to the pitch, roll, and yaw axis. Positioning optical projectors, such as framing projectors, to align projected light with a target requires a great amount of precision, and a gimbal system makes adjusting a framing projector in one direction at a time with accuracy or with small increments difficult. For example, using the gimbal system requires releasing the secure position of the projector in all three axes while attempting to reposition the projector with respect to only one axis. Repositioning often results in the projector alignment shifting in an undesirable axis and the process can be very cumbersome.

There are many instances when accurate alignment between projected image or light and target object are required, such as in stage performance lighting or lighting a work of art, scene, walkway, or defined screen space. In these instances, the ball and socket or gimbal system of aligning projection to target object is inadequate in its ability to accommodate such precision. For example, when using framing projectors, it is necessary to align the light projected from the projector perfectly with the outline of the target object, such as a framed picture. It would be desirable for the use of many projectors to have a mounting and positioning system that allows for fine adjustment by a user in several, independent degrees of freedom relative to the target object until the desired alignment is achieved.

### SUMMARY OF THE INVENTION

The present invention has been developed in response to the present state of the art, and in particular, in response to the problems and needs in the art that have not yet been fully solved by currently available optical projector mounting and positioning systems. Accordingly, the present invention has been developed to provide an apparatus, system, and method for mounting and positioning an optical projector with a greater degree of angular motion, several degrees of lateral motion and with ability to adjust a direction or axis of movement of the optical projector in small increments independently from other directions or axes. These advantages overcome many or all of the above-discussed shortcomings in the art.

The apparatus to mount and position an optical projector is provided with a first base member and a second base member aligned in parallel rows. A first upright arm extends from the first base member and is moveably secured such that the first upright arm is moveable relative to the first base member. A second upright arm opposed to the first upright arm extends from the second base member and is moveably secured such that the second upright arm is moveable relative to the second base member. A cross member extends between the first and second upright arms, and is moveably secured such that it is moveable relative to the first upright arm and the second upright arm. The apparatus includes a mounting bracket attached to an optical projector and is moveably secured to the cross member such that the mounting bracket is moveable relative to the cross member.

In one embodiment, the optical projector is a framing projector. In another embodiment, the mounting bracket is mounted to a bottom of the cross member and the bottom of the cross member is positioned in a direction toward the first and second base members. In another embodiment, the apparatus allows movement of the optical projector in three dimensions and rotation vertically and horizontally.

In one embodiment, the first upright arm is configured to be slideably engaged with the first base member and the second upright arm is configured to be slideably engaged with the second base member. This aspect of the invention provides for ease of adjustment of the optical projector in one linear dimension. In yet another embodiment, the first upright arm is configured to pivot around a first pivot point relative to the first base member and the second upright arm is configured to pivot around a second pivot point relative to the second base member. In this aspect, the invention provides for ease of adjustment of the optical projector in one angular dimension.

In one embodiment, the apparatus includes a second mechanism for fine adjustment permitting the first upright arm to pivot relative to the first base member in small increments. In another embodiment, the cross member is configured to be slideably engaged with the first and second upright arms. In one embodiment, the cross member is slideably engaged with both the first and second upright arms. This aspect provides for ease of adjustment of the optical projector in a second linear dimension. In another embodiment, the cross member may pivot around a third pivot point relative to the first upright arm and pivot around a fourth pivot point relative to the second upright arm. The invention, in this aspect, provides ease of adjustment of the optical projector in a second angular dimension.

The mounting bracket, in one embodiment, is slideably engaged with the cross member. This aspect provides for ease of adjustment of the optical projector in a third linear dimension. In a further embodiment, the mounting bracket may pivot around a fifth pivot point relative to the cross member. This aspect provides for ease of adjustment of the optical projector in a third angular dimension. In one embodiment, the apparatus is further includes a mechanism for fine adjustment permitting the mounting bracket to pivot relative to the cross member in small increments. In yet another embodiment, the apparatus includes a second mechanism for fine adjustment permitting the first upright arm to pivot relative to the first base member in small increments.

In one embodiment, at least one of the first and second base members, the first and second upright arms, and the cross member is a pre-fabricated piece of aluminum with channels. In another embodiment, at least one of the first and second base members, the first and second upright arms, and the cross member has a channel configured for a T-shaped bolt.

A system of the present invention is also presented to mount and position an optical projector. The system includes a mounting and positioning apparatus such as the apparatus described above, a housing unit, and an optical projector. The system may be installed and used to project light or an image onto a target object. The housing unit is configured to accommodate the mounting and positioning apparatus in at least one orientation.

In one embodiment, the mounting and positioning apparatus has a width and a length such that the width equals the length, the first and second base members having holes, the holes aligning with fastening holes in the housing unit in more than one orientation. In another embodiment, the first and second base members sit on a bottom plate of the housing unit. In another embodiment, the housing unit has protrusions in side plates of the housing unit and the first and second base members are mounted to the protrusions.

In certain embodiments, the housing unit may be installed above the ceiling, below the ceiling, on a side wall, in a wall, on the floor, on a table surface, or outdoors. The mounting and positioning apparatus may be secured to a side of the housing unit. Likewise, other embodiments may have the mounting and positioning apparatus secured to the ceiling of the housing unit. In a further embodiment, the housing unit may be configured to have the mounting and positioning apparatus fixedly secured in one orientation with respect to the housing unit. In a yet another embodiment, the housing unit may be configured to have the mounting and positioning apparatus moveable such that the apparatus may be rotated to rest in more than one orientation with respect to the housing unit.

The optical projector may be one of a group of light-emitting opto-mechanical devices used to frame a target object in light such as framing projectors and stage lighting. Although, precision positioning is not a standard requirement for other opto-mechanical devices such as video projectors, transparency projectors, movie projectors, movie cameras or the like, these devices may beneficially be an element of the system in accordance with the present invention.

A method of the present invention is also presented for mounting and positioning an optical projector. The method in the disclosed embodiments substantially includes the steps necessary to carry out the functions presented above with respect to the operation of the described apparatus and system. The method includes aligning a first and second base member in parallel rows. The method includes moveably securing a first upright arm from the first base member such that the first upright arm is moveable relative to the first base member and moveably securing a second upright arm from the second base member such that the second upright arm is moveable relative to the second base member. The method includes moveably securing a cross member between the first and second upright arms such that the cross member is moveable relative to the first and second upright arms. The method includes moveably securing a mounting bracket to the cross member such that the mounting bracket is moveable relative to the cross member and securely attaching an optical projector to the mounting bracket.

In certain embodiments, the method includes slideably engaging the first upright arm with the first base member and the second upright arm with the second base member, and pivoting the first upright arm around a first pivot point relative to the first base member and pivoting the second upright arm around a second pivot point relative to the second base member. In other embodiments, the method includes slideably engaging the cross member with the first upright arm and the second upright arm, pivoting the cross member around a third pivot point relative to the first upright arm, and pivoting the cross member around a fourth pivot point relative to the second upright arm. The method may also include slideably engaging the mounting bracket with the cross member and pivoting the mounting bracket around a fifth pivot point relative to the cross member in increments.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of an apparatus for mounting and positioning an optical projector in accordance with the present invention;

FIG. 2 is an exploded side view and front cross-section view of illustrating the first upright arm extending from the first base member in the embodiment of FIG. 1;

FIG. 3A is an exploded side view illustrating another embodiment of the first upright arm extending from the first base member;

FIG. 3B is an exploded front cross-section view of the embodiment of FIG. 3A;

FIG. 4 is an exploded view of one embodiment of first and second mechanisms for fine adjustment in accordance with the present invention; and

FIG. 5 is a perspective view illustrating one embodiment of a system for mounting and positioning an optical projector in accordance with the present invention;

FIG. 6 is a schematic flow chart diagram illustrating one embodiment of a method for mounting and positioning an optical projector in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

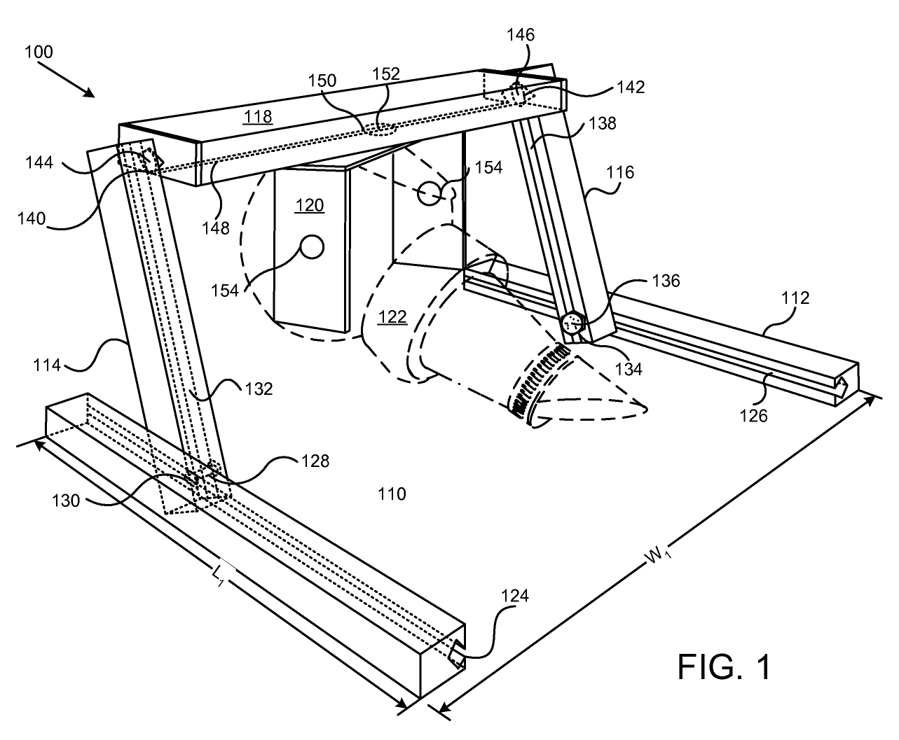

FIG. 1 depicts a perspective view of one embodiment of an apparatus 100 according to the present invention. The mounting and positioning apparatus 100 comprises a first base member 110, a second base member 112, a first upright arm 114, a second upright arm 116, a cross member 118, and a mounting bracket 120. The members and arms 110, 112, 114, 116, 118 as well as the mounting bracket 120 are made of a sturdy material, such that when the apparatus 100 is fully assembled, there is sufficient structural integrity to freely stand and support the weight of an optical projector 122. For example, the members and arms 110, 112, 114, 116, 118 as well as the mounting bracket 120 may be made of aluminum, steel, rigid plastic, fiberglass, or other rigid material. In other embodiments, one or more members and arms 110, 112, 114, 116, 118 may be made of a prefabricated piece of extruded aluminum with channels, such as those manufactured by Faztek®. Those of ordinary skill in the art recognize that the size of each member or arm 110, 112, 114, 116, 118, the mounting bracket 120 and the overall size of the apparatus 100 may vary to accommodate various projector sizes or restrictions without greatly affecting the benefits of the present invention.

In one embodiment, the optical projector 122 is a framing projector. In another embodiment, the optical projector 122 is a spot light. In other embodiments, the optical projector 122 may be a video projector, a transparency projector, or any projector that projects an image from a negative template such as a slide or movie projector. It is apparent to one of ordinary skill in the art that several opto-mechanical devices may beneficially be mounted and positioned with the apparatus 100 in accordance with the present invention.

The first base member 110 and the second base member 112 support the apparatus 100 and are positioned in parallel rows. In one embodiment, the length L₁ of the first base member 110 is equal to the length (not shown) of the second base member 112. In a further embodiment, the width W₁ between the first base member 110 and the second base member 112 is equal to the length L₁ of the first base member 110 and the length (not shown) of the second base member 112. As shown in FIG. 1, the first base member 110 has a first channel 124 extending longitudinally along the first base member 110. The second base member 112 has a second channel 126 extending longitudinally along the second base member 112. The first base member 110 may have additional channels 124 and the second base member 112 may have additional channels 126.

The first upright arm 114 extends from the first base member 110 and is secured such that the first upright arm 114 is moveable relative to the first base member 110. In the embodiment shown in FIG. 1, the first upright arm 114 is slideably engaged with the first channel 124 and is releaseably secured with a first fastener 128. The first fastener 128 may be loosened to allow the first upright arm 114 to be moveable relative to the first base member 110 or the first fastener 128 may be tightened to allow the first upright arm 114 to be stationary with respect to the first base member 110. When the first fastener 128 is loose, the first upright arm 114 may slide along the first channel 124 and may pivot around a first pivot point 130. The pivot point 130 may move along the first channel 124 as the first upright arm 114 slideably engages the first channel 124 to move along the length L₁ of the first base member 110. The first upright arm 114 is provided with a third channel 132 that extends longitudinally along the first upright arm 114.

The second upright arm 116 extends from the second base member 112 and is secured such that the second upright arm 116 is moveable relative to the second base member 112. In one embodiment, the second upright arm 116 is slideably engaged with the second channel 126 and is releaseably secured with a second fastener 134. The second fastener 134 may be loosened to allow the second upright arm 116 to be moveable relative to the second base member 112 or the second fastener 134 may be tightened to allow the second upright arm 116 to be stationary with respect to the second base member 112. When the second fastener 134 is loose, the second upright arm 116 may slide along the second channel 126 and may pivot around a second pivot point 136. The pivot point 136 may move along the second channel 126 as the second upright arm 116 slideably engages the second channel 126 to move along the second base member 112. The second upright arm 116 is provided with a fourth channel 138 that extends longitudinally along the second upright arm 116.

The cross member 118 extends between the first upright arm 114 and the second upright arm 116 such that the cross member 118 is moveable relative to the first and second upright arms 114, 116. In the embodiment, as illustrated in FIG. 1, the cross member 118 is slideably engaged with the third channel 132 and is releaseably secured with a third fastener 140 to the first upright arm 114. The cross member 118 is slideably engaged with the fourth channel 138 and is releaseably secured with a fourth fastener 142 to the second upright arm 116. The third fastener 140 may be loosened to allow the cross member 118 to be moveable relative to the first upright arm 114 or the third fastener 140 may be tightened to allow the cross member 118 to be stationary with respect to the first upright arm 114. When the third fastener 140 is loose, the cross member 118 may slide along the third channel 132 and may pivot around a third pivot point 144. The fourth fastener 142 may be loosened to allow the cross member 118 to be moveable relative to the second upright arm 116 or the fourth fastener 142 may be tightened to allow the cross member 118 to be stationary with respect to the second upright arm 116. When the fourth fastener 142 is loose, the cross member 118 may slide along the fourth channel 138 and may pivot around a fourth pivot point 146. The movement of the cross member 118 with respect to the first upright arm 114 and the second upright arm 116 may be substantially the same. Additionally, the pivot points 144, 146 may move along channels 132, 138 in conjunction with the slideable movement of the cross member 118 along the channels 132, 138. In one embodiment, the cross member 118 is provided with a fifth channel 148 that extends longitudinally along the cross member 118.

The mounting bracket 120 is secured to the cross member 118 such that the mounting bracket 120 is moveable relative to the cross member 118. In the embodiment illustrated by FIG. 1, the mounting bracket 120 is slideably engaged with the fifth channel 148 and is releaseably secured with a fifth fastener 150 to the cross member 118. The fifth fastener 150 may be loosened to allow the mounting bracket 120 to be moveable relative to the cross member 118 or the fifth fastener 150 may be tightened to allow the mounting bracket 120 to be stationary with respect to the cross member 118. When the fifth fastener 150 is loose, the mounting bracket may slide along the fifth channel 148 and may pivot around a fifth pivot point 152. The pivot point 152 may move long the fifth channel 148 as the mounting bracket 120 moves along the fifth channel 148.

The mounting bracket 120 is further configured to securely attach the optical projector 122. The optical projector 122 may be attached with a securing mechanism 154. The securing mechanism 154, as used herein, is any element that connects the mounting bracket 120 to the optical projector 122 such that the optical projector 122 may not move relative to the mounting bracket 120. Those skilled in the art will appreciate that a securing mechanism 154 may be a screw, a bolt, adhesive, corresponding hook and loop strips, or other such securing element.

A fastener 128, 134, 140, 142, 150, 154, as used herein, is any element that connects an upright arm 114, 116 to a member 110, 112, 118 or the mounting bracket 120 to the cross member 118 such that in one position the fastener is loose and allows for movement and in a second position the fastener is tight and inhibits movement. One skilled in the art will appreciate that a fastener may be a T-bolt, screw and nut, a rivet, or other such fastening device.

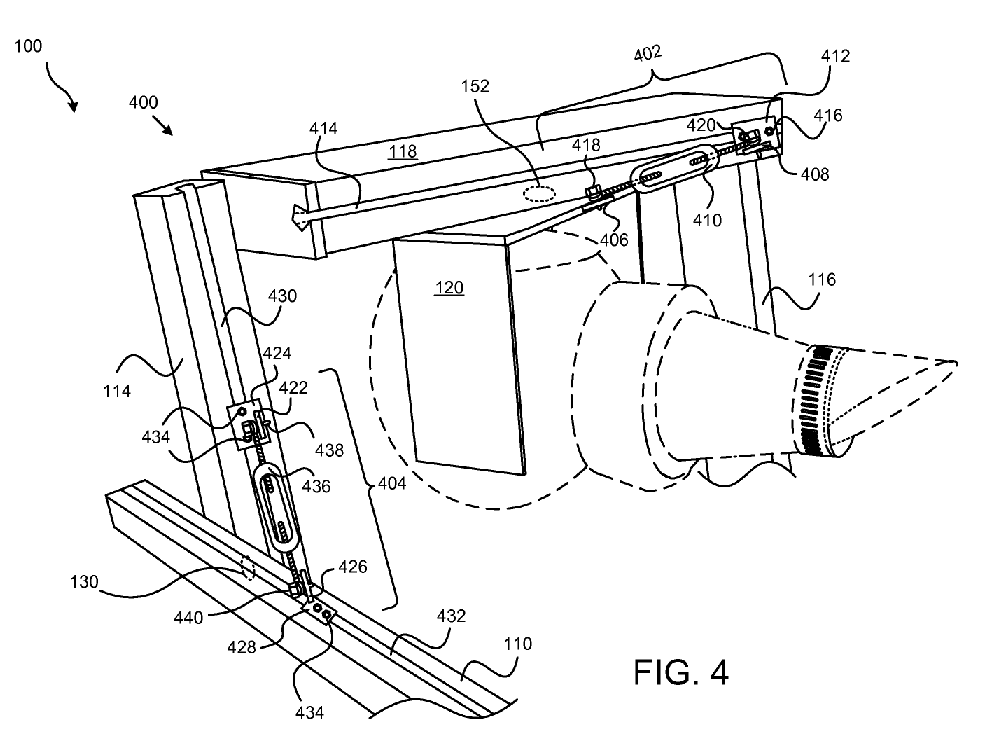

The channels 124, 126, 132, 138, 148 may be a channel with notches 124, 126, 132, 148 (as shown in FIG. 1) disposed in the members 110, 112, 118 or arms 114, 116 that are designed to accommodate a T-bolt, screw or other bolt with widened head attached to a bolt shaft. In another embodiment, the channels 124, 132, 138, 148 may be a straight channel to accommodate a fastener with an expansion element to hold the fastener in place. In these embodiments, a nut may secure the fastener outside of the channel 124, 126, 132, 138, 148. In other embodiments, the channels 124, 126, 132, 138, 148 may traverse through the members 110, 112, 118 or arms 114, 116 such that a fastener may extend through the members 110, 112, 118 or arms 114, 116. In this embodiment, a nut may secure the fastener on either side of the channel 124, 126, 132, 138, 148 or both. In other embodiments, the base members 110, 112, upright arms 114, 116, and cross member 118 include more channels; some of which are depicted with respect to FIG. 4. In one embodiment, the base members 110, 112, upright arms 114, 116, and cross member 118 include channels on four sides. One of ordinary skill in the art will recognize that other channels and fasteners are available.

One of ordinary skill in the art will recognize that the first and second upright arms 114, 116 may be moveable relative to the first and second base member 110, 112 using other configurations such as using a series of holes in the base member 110, 112 that are configured to receive a securing fastener extending through the upright arm 114, 116. The number of holes in the base member 110, 112 will determine the number of finite positions the upright arms 114, 116 may take relative to the base members 110, 112. Likewise, the cross member 118 may be moveable relative to the first and second upright arms 114, 116 using other configurations such as a series of holes in the upright arms 114, 116 that are configured to receive a securing fastener extending through the cross member 118.

In another embodiment, a clamp attaches to the first and second base members 110, 112 and to the upright arms 114, 116. In yet another embodiment, the base members 110, 112 and upright arms 114, 116 are slideably connected using a combination of channels, holes, clamps, etc. One of skill in the art will recognize other ways that a base member 110, 112 may be slideably connected to an upright arm 114, 116.

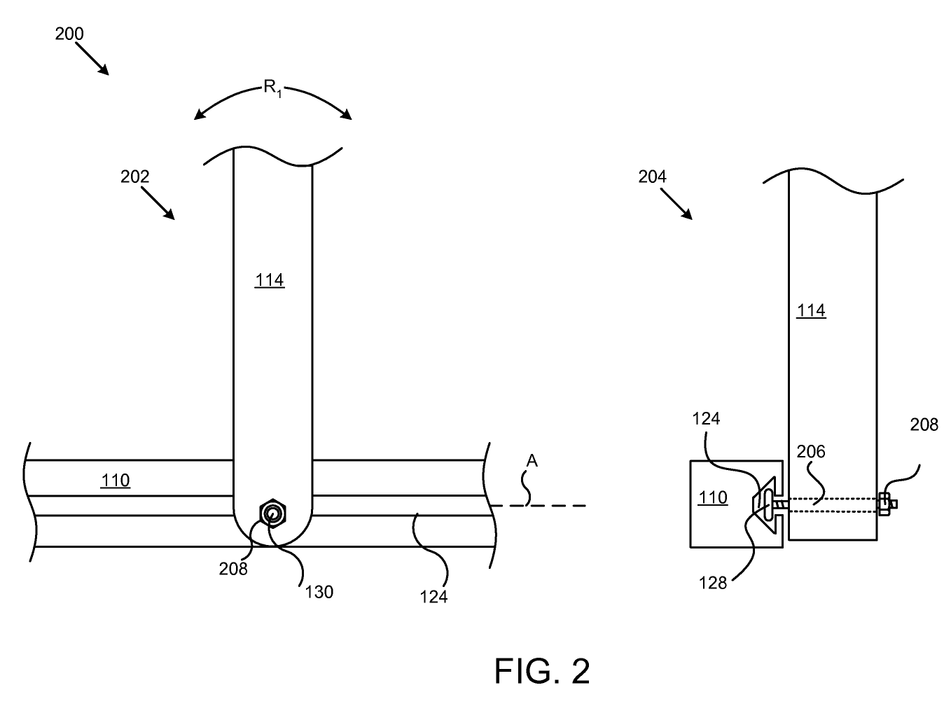

FIG. 2 illustrates a side view 202 and front cross-section view 204 of the slideable engagement between the first upright arm 114 and the first base member 110 of FIG. 1. The first fastener 128 engages a hole 206 disposed in the first upright arm 114 and the first channel 124. When the first fastener 128 is loose, the first upright arm 114 may slide along axis A. Additionally, when the first fastener 128 is loose, the first upright arm 114 may pivot about the first pivot point 130 along arc R₁. While a connection between the first base member 110 and first upright arm 114 are depicted in FIG. 2, the illustration applies equally to the second base member 112 and second upright arm 114. The concept depicted in FIG. 2 of a channel and T-bolt may also be applied to any other connection of the apparatus 100.

The first fastener 128 may be a T-bolt that extends through the hole 206 in the first upright arm 114 and is secured in the first channel 124. A nut 208 may be used to tighten the connection between the first upright arm 114 and the first base member 110. The nut 208 may be loosened to allow the first fastener 128 to slide in the first channel 124, or tightened to hold the fastener 128 securely within the channel 124. One of ordinary skill in the art will recognize that the second base member 112 and the second upright arm 116 as well as the slideable engagement of the cross member 118 to the first and second upright arms 114, 116 may have similar channels 124 and fasteners 128.

In another embodiment, the nut 208 to tighten the connection between the first upright arm 114 and the first base member 110 is a wing-nut. In another embodiment, the nut 208 includes a lever that allows tightening without tools. In yet another embodiment, the nut 208 includes a compression fitting where a lever is rotated to apply pressure to a base member 110 and an upright arm 114. One of skill in the art will recognize other ways to tighten a connection between a base member 110 and an upright arm 114. In addition, other variations of the nut 208 may be applied to other connections of the apparatus 100.

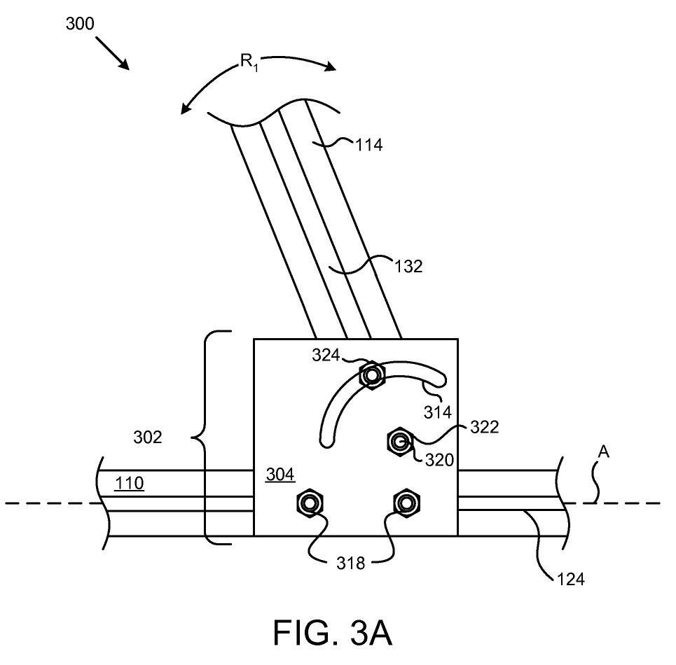

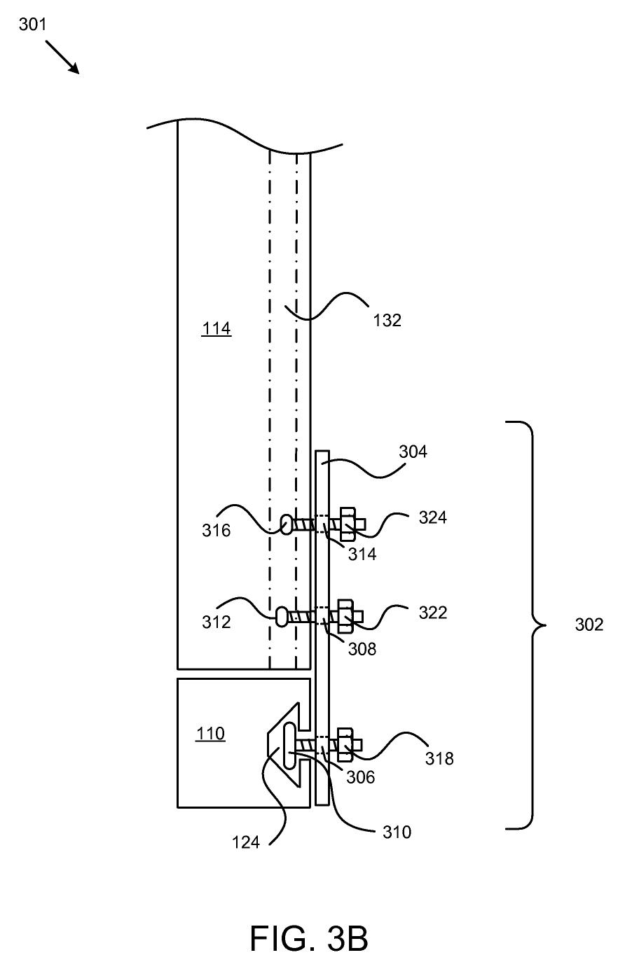

FIG. 3A illustrates a side view 300 of a further embodiment of the slideable engagement between the first upright arm 114 and the first base member 110. FIG. 3B is an exploded front cross-section view 301 of the embodiment of FIG. 3A. In this embodiment, the apparatus 100 further comprises a mounting mechanism 302 adapted to provide a moveable connection between the first upright arm 114 and the first base member 110. The mounting mechanism 302 further comprises a flat plate 304 having holes 306, 308 for receiving fasteners such as T-bolts 310, 312 and an arch slot 314 for receiving a fastener such as a T-bolt 316. In one embodiment, one or more sliding T-bolts 310 extend through holes 306 in the flat plate 304 and slideably engage in the first channel 124 connecting the flat plate 304 to the first base member 110. Sliding T-bolt nuts 318 threadably engage T-bolts 310 to loosen or tighten the mounting mechanism 302 to the first base member 110. The sliding T-bolt nuts 318 may be loosened to allow the mounting mechanism 302 and the first upright arm 114 to slide along axis A. Alternatively, the sliding T-bolt nuts 318 may be tightened such that the mounting mechanism 302 and the first upright arm 114 is stationary with respect to movement along axis A. In another embodiment, the flat plate 304 has additional holes 306 configured to receive additional sliding T-bolts 310 and nuts 318.

In one embodiment, a pivot T-bolt 312 extends through a hole 308 in the flat plate 304 and threadably secures the first upright arm 114 to the flat plate 304 such that the first upright arm 114 may pivot around a pivot point 320. In one embodiment, a pivot T-bolt nut 322 threadably engages pivot T-bolt 312 to loosen or tighten the mounting mechanism 302 to the first upright arm 114. The nut 322 may be loosened to allow the first upright arm 114 to pivot around the pivot point 320. The nut 322 may be tightened such that the first upright arm 114 is stationary with respect to movement around the pivot point 320. In another embodiment, the pivot point 320 includes a pin, fixed bolt, rivet, etc. and freely allows the upright arm 114 to move with respect to the flat plate 304. The pivot point 320 may move along axis “A” in conjunction the slideable movement of the mounting mechanism 302 along axis “A”.

In one embodiment, an arch T-bolt 316 extends through the arch slot 314 and slideably engages in the third channel 132 of the first upright arm 114 such that the first upright arm 114 may pivot around the pivot point 320 along the arch slot 314 about arc R₁. In one example, an arch T-bolt nut 324 threadably engages the arch T-bolt 316 to loosen or tighten the mounting mechanism 302 to the first upright arm 114. The pivot and arch T-bolt nuts 322, 324 may be loosened with respect to T-bolts 312, 316 to allow the first upright arm 114 to pivot around the pivot point 320 along the arch slot 314. In another example, the pivot point 320 includes a pin, fixed bolt, etc. and the arch T-bolt nut 324 is loosened to rotate the upright arm 114 with respect to the pivot point 320. In addition, the pivot and arch T-bolt nuts 322, 324 may be tightened such that the first upright arm 114 is stationary with respect to the arch slot 314.

In another embodiment, the arch slot 314 is replaced with a series of holes in an arch pattern and the arch T-bolt 316 and nut 324 are replaced with bolts or other means to extend through the holes to position the upright arm 114 with respect to the pivot point 320. The mounting mechanism 302 depicted in FIGS. 3A and 3B apply equally as well to the second base member 112 and second upright element 116. The mounting mechanism 302, in another embodiment, may also apply in a modified form to the cross member 118 and connection to an upright element 114, 116.

FIG. 4 is an exploded perspective view 400 illustrating one embodiment for first and second mechanisms for fine adjustment 402, 404. The mounting and positioning apparatus 100 illustrated in FIG. 1 may further comprise a first mechanism for fine adjustment 402, wherein the first mechanism for fine adjustment 402 permits the mounting bracket 120 to pivot around a fifth pivot point 152 relative to the cross member 118 in small increments.

The first mechanism for fine adjustment 402 is connected on a first attachment site 406 to the mounting bracket 120 and on a second attachment site 408 to the cross member 118. In another embodiment, the second attachment site 408 may be connected to one of the first upright arm 114 or the second upright arm 116. The first attachment site 406 is connected to the second attachment site 408 such that the first attachment site 406 may move relative to the second attachment 408 site in increments. A connection device 410 is used to connect the first attachment site 406 to the second attachment site 408 and, in one embodiment may comprise a turnbuckle. One of ordinary skill in the art will appreciate that the connection device 410 may be any element that provides for an incremental movement of the first attachment site 406 relative to the second attachment site 408 such as a screw and nut, a gear rack and ratchet device, and other similar devices.

The first mechanism for fine adjustment 402, may further comprise a slideable connection plate 412 wherein the slideable connection plate 412 is slideably engaged with a sixth channel 414 disposed in and extending longitudinally along the cross member 118. The slideable connection plate 412 may be engaged in the sixth channel 414 with T-bolts (not shown) and threadably secured with slideable T-bolt nuts 416. The second attachment site 408 of the first mechanism for fine adjustment 402, in one embodiment, is attached to the slideable connection plate 412 such that the first mechanism for fine adjustment 402 may be positioned anywhere along the cross member 118 and used for fine adjustment of the mounting bracket 120 around the fifth pivot point 152.

The turnbuckle 410 may be provided with first and second mounting pins 418, 420 such that the first pin 418 secures the turnbuckle 410 to the first attachment site 406 and the second pin secures the turnbuckle 410 to the second attachment site 408. On of ordinary skill in the art will recognize that mounting pins 418, 420 may be any securing element that joins the turnbuckle 410 to the attachment site 406, 408 such as straight pin or rod, a screw or nail, welding, and the like. Rotational turning of the turnbuckle 410 will increase or decrease the distance between the first and second attachment sites 406, 408. Incremental movement of the first attachment site 406 closer to or further from the second attachment site 408 causes the mounting bracket 120 to pivot around the fifth pivot point 152.

The apparatus 100 may also be provided with a second mechanism of fine adjustment 404 wherein the second mechanism for fine adjustment 404 permits the first upright arm 114 to pivot around the first pivot point 130 relative to the first base member 110 in small increments. The second mechanism of fine adjustment 404 may be further provided with an arm attachment site 422 connected, in one embodiment, to a slideable arm connection plate 424 and a base attachment site 426 connected to a slideable base connection plate 428. In one embodiment, the arm connection plate 424 may be slideably engaged in a seventh channel 430 disposed in and extending longitudinally along the first upright arm 114.

Likewise, the base connection plate 428 may be slideably engaged in an eighth channel 432 disposed in and extending longitudinally along the first base member 110. The connection plates 424, 428 may engage the channels 430, 432 with T-bolts (not shown), or other fastener recognized in the art, and threadably secured with nuts 434, wing-nuts, levered nuts, etc. It is also appreciated by one of ordinary skill in the art that the arm attachment site 422 may be a secure attachment to the first upright arm 114 or may be moveably attached to the first upright arm 114 by other means. Likewise, the base attachment site 426 may be a secure attachment to the first base member 110 or may be moveably attached to the first base member 110 by other means.

A connection device 436 is used to connect the arm attachment site 422 to the base attachment site 426 and, in one embodiment may comprise a turnbuckle 436. One of ordinary skill in the art will appreciate that the connection device 436 may be any element that provides for an incremental movement of the arm attachment site 422 relative to the base attachment site 426 such as a screw and nut, a gear rack and ratchet device, and other similar devices.

The turnbuckle 436 may be provided with arm and base mounting pins 438, 440 such that the arm pin 438 secures the turnbuckle 436 to the arm attachment site 422 and the base pin 440 secures the turnbuckle 436 to the base attachment site 426. One of ordinary skill in the art will recognize that mounting pins 438, 440 may be any securing element that joins the turnbuckle 436 to the attachment site 422, 426 such as straight pin or rod, a screw or nail, welding, and the like. Rotational turning of the turnbuckle 436 will increase or decrease the distance between the arm and base attachment sites 422, 426. Incremental movement of the arm attachment site 422 closer to or further from the base attachment site 426 causes the first upright arm 114 to pivot around the first pivot point 130.

In further embodiments, connection devices 410, 436 may be used for fine adjustment of movement of the second upright arm 116 around the second pivot point 136. In other embodiments, connection devices 410, 436 may be used to incrementally adjust movement of the cross member 118 around the third and fourth pivot points 144, 146.

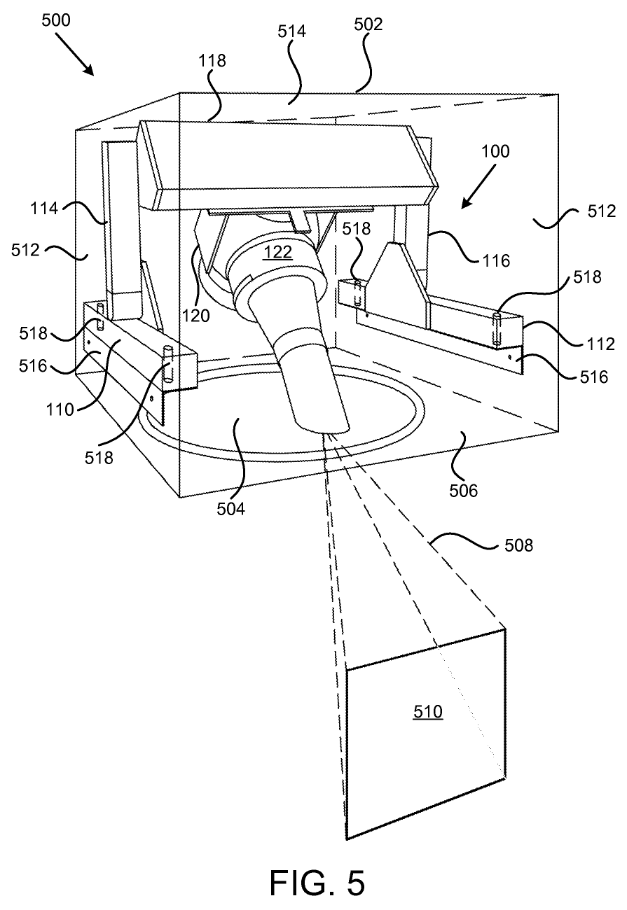

The present invention also provides a system for mounting and positioning an optical projector 122. FIG. 5 illustrates one embodiment of the system 500 comprising a mounting and positioning apparatus 100, a housing unit 502 configured to accommodate the mounting and positioning apparatus 100 in at least one orientation, and an optical projector 122. The mounting and positioning apparatus 100, in one embodiment, includes first and second base members 110, 112, first and second upright arms 114, 116, a cross member 118, and a mounting bracket 120. The housing unit 502 may be further configured to have an opening 504 in a bottom surface 506 of the housing unit 502 such that when positioned, the optical projector 122 is aligned with the opening 504. The optical projector 122 is positioned such that the projection of light 508 or an image aligns with a target object 510. In another embodiment (not shown), the opening 504 may be disposed in a side surface 512 or a top surface 514 of the housing unit 502.

The housing unit 502 may be any enclosure that provides space for the mounting and positioning apparatus 100 and the optical projector 122. In one embodiment, the first and second base members 110, 112 may sit on a bottom surface 506 of the housing unit 502. In another embodiment, the housing unit 502 has brackets 516 or similar protrusions in the side surfaces 512 configured such that the first and second base members 110, 112 may sit on the brackets 516. Beneficially, the mounting and positioning apparatus 100 may be accommodated, in other embodiments, such that the base members 110, 112 are secured to the side surfaces 512 or a ceiling surface 514 of the housing unit 502.

In a further embodiment, the first and second base members 110, 112 may be either permanently or temporarily secured to a surface 506, 512, 514. As one of ordinary skill in the art will appreciate, the base members 110, 112 may be secured to the housing unit 502 using adhesive, screws, nails, bolts and nuts, or other fasteners of the like. Temporary securing devices may include straps, hook and loop strips, tape, and other such removable devices. In some embodiments, the base members 110, 112 may have holes 518 aligned with holes (not shown) in the brackets 516 or housing unit 502 such that the holes 518 may accommodate a fastener (not shown) for securing the mounting and positioning apparatus 100 to the bracket 516 or housing unit 502.

In one embodiment, the housing unit 502 may be configured to accommodate the mounting and positioning apparatus 100 in one orientation with respect to the housing unit 502. In a further embodiment, the housing unit 502 may be configured to have the mounting and positioning apparatus 100 moveable such that the mounting and positioning apparatus 100 may be resting in more than one orientation with respect to the housing unit 502.

In one aspect, the width W₁ of the mounting and positioning apparatus 100 is equal to the length L₁ of the first and second base members 110, 112 such that the mounting and positioning apparatus 100 forms a square that may be turned 90 degrees with respect to the housing unit 502. In certain embodiments in which the apparatus 100 forms a square, the holes 518 may align with holes (not shown) in the brackets 516 of the housing unit 502 in one orientation and when the apparatus 100 is turned 90 degrees, the holes 518 align with the same holes (not shown) in the brackets 516 of the housing unit 502. Holes (not shown) may be disposed in other surfaces 506, 512, 514 such that the square apparatus 100 may turn 90 degrees and re-attach using the same holes.

The optical projector 122 may be one of a group of light-emitting opto-mechanical devices used to frame a target object 510 in light 508 or to project an image on a target object 510. These include, but are not limited to, framing projectors, spotlights, video projectors, and transparency projectors such as movie and slide projectors.

In one embodiment, the housing unit 502, mounting and positioning apparatus 100, and the optical projector 122 may be installed above a ceiling of a dwelling, building, or other indoor facility, such that only the opening 504 is exposed to an interior space below. In this aspect, the optical projector 122, when positioned, may project light 508 while mounted above the ceiling onto a target object 510 located below the ceiling. In another embodiment, the system 500 may be installed below the ceiling. The system 500, in further embodiments, may be installed on side walls of an interior space as well as in walls, such that only the opening 504 is exposed to the interior space through the wall. In certain embodiments, the system 500 may be installed or placed on a floor or other table surface. In yet another embodiment, the system 500 may be installed outdoors. One of ordinary skill in the art will recognize that the system 500 may be installed in other locations and the system used to align projected light 508 on to a variety of target objects 510.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

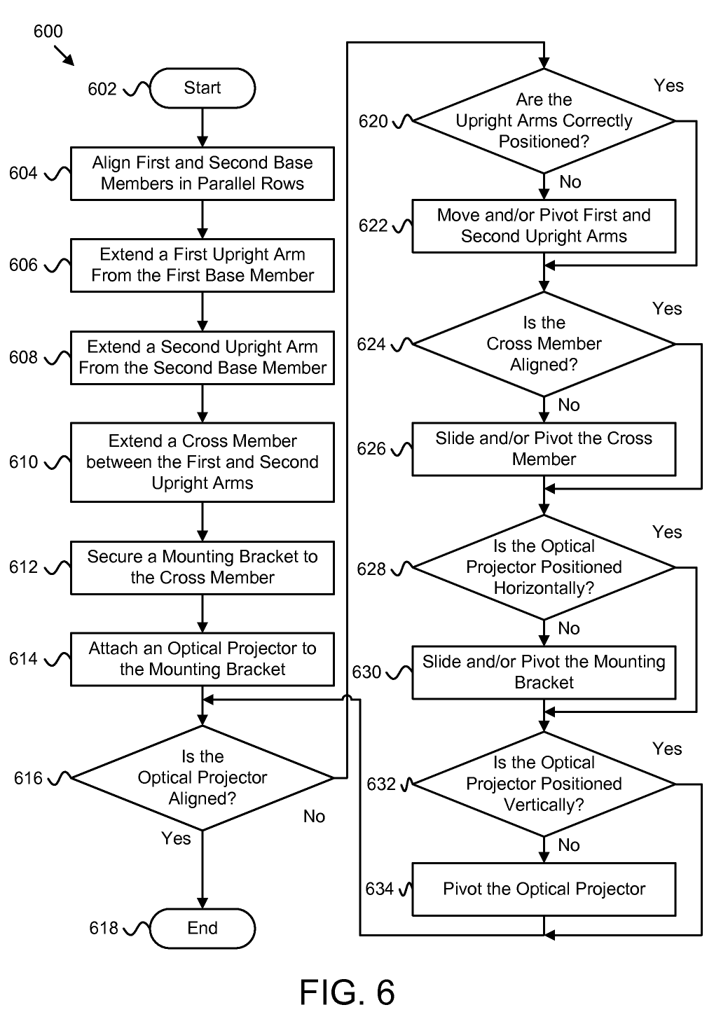

FIG. 6 illustrates one embodiment of an optical projector mounting and positioning method 600 in accordance with the present invention. The method 600 begins 602 and includes aligning 604 a first and second base member 110, 112 in parallel rows. The first and second base members 110, 112 are aligned, in one embodiment, so that the distance between base members 110, 112, W₁, is equal to the length of the base members 110, 112, L₁, thus forming a square. A square pattern is beneficial because the mounting and positioning apparatus 100 will align with mounting holes 518 and fasteners in a first position and also in a second position where the apparatus 100 is rotated 90 degrees.

The method 600 includes extending 606 a first upright arm 114 from the first base member 110 and extending 608 a second upright arm 116 from the second base member 112. The upright members 114, 116 are slideably connected to the base members 110, 112 and may slide along the horizontal dimension of the base members 110, 112. The upright members 114, 116 may also rotate with respect to the base members 114, 116 about pivot points 130, 136. The upright arms 114, 116 may slide and pivot when fasteners 128, 134, such as T-bolts, that extend into channels 124, 126 on the base members 110, 112 are loosened. In one embodiment, the base members 110, 112 and upright arms 114, 116 are connected to a flat plate 304.

In one embodiment, a second fine adjustment mechanism 404 is connected between the first base member 110 and first upright arm 114, or between the second base member 112 and second upright arm 116, or both. The one or more second fine adjustment mechanisms 404 allow fine movement of the upright arms 114, 116 with respect to the base members 110, 112, thus allowing fine adjustment for precise positioning of an optical projector 122.

The method 600 includes extending 610 a cross member 118 between the first and second upright arms 114, 116. The cross member 118 is slideably attached to the upright arms 114, 116 with fasteners 140, 142, such as T-bolts, that extend into channels 132, 138 in the upright arms 114, 116. The cross member 118 may also rotate about pivot points 144, 146 to rotate the cross member 118 with respect to the upright arms 114, 116.

The method 600 includes securing 612 a mounting bracket 120 to the cross member 118. In one embodiment, the mounting bracket 120 is slideably secured 612 to the mounting bracket 120 using a fastener 150 extended into a channel 148 in the cross member 118. The mounting bracket 120 may slide along the channel 148 when the fastener 150 is loosened. In addition, the mounting bracket 120 may pivot with respect to the cross member 118 around a pivot point 152 formed with the fastener 150. In another embodiment, the mounting bracket 120 includes an arch-shaped slot similar to the arch slot 314 described in relation to FIGS. 3A and 3B. The arch-shaped slot may include a second fastener connected to channel 148 of the cross member 118 or another location.

In one embodiment, a first fine adjustment mechanism 402 may connect the mounting bracket 120 with the cross member 118. The first fine adjustment mechanism 402 may slideably connect to a channel 414 the cross member 118. The first fine adjustment mechanism 402 allows fine movement of the mounting bracket 120 with respect to the cross member 118 for precise positioning of the optical projector 122 when positioning a projected beam of light onto a target.

The method 600 includes attaching 614 an optical projector 122 to the mounting bracket 120. The attachment point between the optical projector 122 and the mounting bracket 120, in one embodiment, forms a pivot point 154 so the optical projector 122 may pivot with respect to the mounting bracket 120. In one embodiment, a fine adjustment mechanism is connected between the mounting bracket 120 and the optical projector for fine adjustment of the optical projector 122 with respect to the mounting bracket 120. The fine adjustment mechanism may be similar to the first and second fine adjustment mechanisms 402, 404, may be a ratcheting mechanism at the attachment point between the bracket 120 and projector 122 at the pivot point 154, or may be any other mechanism allowing precision movement of the projector 122 with respect to the bracket 120.

The method 600 determines 616 if the optical projector 122 is aligned so that a projected beam of light is properly positioned on a target 510. If the method 600 determines 616 that the optical projector 122 is aligned, the method 600 ends 618. If the method 600 determines 616 that the optical projector 122 is not aligned, the method 600 determines 620 if the upright arms 114, 116 are correctly positioned. If the method 600 determines 620 that the upright arms 114, 116 are not correctly positioned, the upright arms 114, 116 are moved and/or pivoted with respect to the base members 110, 112 and the method 600 determines 624 if the cross member 118 is aligned. If the method 600 determines 620 that the upright arms 114, 116 are correctly positioned, the method 600 determines 624 if the cross member 118 is aligned.

If the method 600 determines 624 that the cross member 118 is not aligned, the cross member 118 is slid 626, in one embodiment, up or down with respect to the upright arms 114, 116. In another embodiment, the cross member 118 is pivoted 626 with respect to the upright members 114, 116. The method 600 then determines 628 if the optical projector 122 is correctly positioned horizontally (with respect to a plane formed by the bottom of the base members 110, 112). If the method 600 determines 624 that the cross member 118 is aligned, the method 600 determines 628 if the optical projector 122 is correctly positioned horizontally.

If the method 600 determines 628 that the optical projector 122 is not correctly positioned horizontally, the mounting bracket 120 is slid 630, in one embodiment, along the channel 148 in the cross member 118. In another embodiment, the mounting bracket 120 is pivoted 630 with respect to the cross member 118. The method 600 then determines 632 if the optical projector 122 is positioned vertically. If the method 600 determines 628 that the optical projector 122 is correctly positioned horizontally, the method 600 determines 632 if the optical projector 122 is positioned vertically.

If the method 600 determines 632 that the optical projector 122 is not positioned vertically, the optical projector 122 is pivoted 634 with respect to the mounting bracket 120. In another embodiment, the cross member 118 is pivoted 626 to provide vertical positioning of the optical projector 122. The method 600 then determines 616 if the optical projector 122 is aligned. If the method 600 determines 632 that the optical projector 122 is positioned vertically, the method 600 determines 616 if the optical projector 122 is aligned. If the method 600 determines 616 that the optical projector 122 is not aligned, the method 600 repeats the positioning steps described above. If the method 600 determines 616 that the optical projector 122 is aligned, the method 600 ends 618.

The optical projector 122 may be aligned with a target object 510 using the method 600. In certain embodiments, the method 600 may be used once to mount and position an optical projector 122. Alternatively, the method 600 may be used many times to mount and position an optical projector 122 to align with a target object 510 that moves or a second target object 510. In addition, the method 600 may include other steps, such as replacing a lamp, attaching a filter, attaching and adjusting a slide with a cutout to frame the target object 510, etc. The method 600 may also be used to retrofit an existing light fixture with a new mounting and positioning apparatus 100. One of skill in the art will recognize other steps that may be added to the method 600, steps that may be omitted, and other uses for the mounting and positioning apparatus 100.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A mounting and positioning apparatus for an optical projector, the apparatus comprising:
a first base member and second base member aligned in parallel rows;
a first upright arm extending from the first base member and moveably secured such that the first upright arm is moveable relative to the first base member;
a second upright arm opposed to the first upright arm, extending from the second base member and moveably secured such that the second upright arm is moveable relative to the second base member;
a cross member extending between the first and second upright arms, and moveably secured such that it is moveable relative to the first upright arm and the second upright arm; and
a mounting bracket configured to attach to an optical projector and moveably secured to the cross member such that the mounting bracket is moveable relative to the cross member.

2. The apparatus of claim 1, wherein the optical projector is a framing projector.

3. The apparatus of claim 1, wherein the mounting bracket is mounted to a bottom of the cross member, the bottom of the cross member positioned in a direction toward the first and second base members.

4. The apparatus of claim 1, wherein the apparatus allows movement of the optical projector in three dimensions and rotation vertically and horizontally.

5. The apparatus of claim 1, wherein the first upright arm is slideably engaged with the first base member and the second upright arm is slideably engaged with the second base member.

6. The apparatus of claim 1, wherein the first upright arm pivots around a first pivot point relative to the first base member and the second upright arm pivots around a second pivot point relative to the second base member.

7. The apparatus of claim 1, wherein the cross member is slideably engaged with the first upright arm and the second upright arm.

8. The apparatus of claim 1, wherein the cross member pivots around a third pivot point relative to the first upright arm and pivots around a fourth pivot point relative to the second upright arm such that the cross member pivots simultaneously in the same degree and in the same direction around the third pivot point and the fourth pivot point.

9. The apparatus of claim 1, wherein the mounting bracket is slideably engaged with the cross member.

10. The apparatus of claim 1, wherein the mounting bracket pivots around a fifth pivot point relative to the cross member.

11. The apparatus of claim 10, further comprising a mechanism for fine adjustment permitting the mounting bracket to pivot relative to the cross member in small increments.

12. The apparatus of claim 6, further comprising a second mechanism for fine adjustment permitting the first upright arm to pivot relative to the first base member in small increments.

13. The apparatus of claim 1, wherein at least one of the first and second base members, the first and second upright arms, and the cross member is a pre-fabricated piece of aluminum with channels.

14. The apparatus of claim 1, wherein at least one of the first and second base members, the first and second upright arms, and the cross member has a channel configured for a T-shaped bolt.

15. A system for mounting and positioning an optical projector, the system comprising:
a mounting and positioning apparatus, the mounting and positioning apparatus comprising:
a first base member and second base member aligned in parallel rows;
a first upright arm extending from the first base member and moveably secured such that the first upright arm is moveable relative to the first base member;
a second upright arm opposed to the first upright arm, extending from the second base member and moveably secured such that the second upright arm is moveable relative to the second base member;
a cross member extending between the first upright arm and the second upright arm, and moveably secured such that it is moveable relative to the pair of opposed upright arms; and
a mounting bracket moveably secured to the cross member such that the mounting bracket is moveable relative to the cross member;
a housing unit, the housing unit configured to accommodate the mounting and positioning apparatus in at least one orientation; and
an optical projector wherein the optical projector is securely attached to the mounting bracket.

16. The system of claim 0, wherein the mounting and positioning apparatus has a width and a length such that the width equals the length, the first and second base members having holes, the holes aligning with fastening holes in the housing unit in more than one orientation.

17. The system of claim 16, wherein the housing unit further comprises protrusions in side plates of the housing unit and the first and second base members are mounted to the protrusions.

18. The system of claim 0, wherein the housing unit may be installed in a position, the position being one of above the ceiling, below the ceiling, on a side wall, in a wall, on the floor, on a table surface, and outdoors.

19. A method for mounting and positioning an optical projector, the method comprising:
aligning a first base member and a second base member in parallel rows;
moveably securing a first upright arm from the first base member such that the first upright arm is moveable relative to the first base member;
moveably securing a second upright arm from the second base member such that the second upright arm is moveable relative to the second base member.
moveably securing a cross member between the first upright arm and the second upright arm such that the cross member is moveable relative to the first upright arm and the second upright arm;
moveably securing a mounting bracket to the cross member such that the mounting bracket is moveable relative to the cross member; and
attaching an optical projector to the mounting bracket.

20. The method of claim 19, further comprising slideably engaging the first upright arm with the first base member and the second upright arm with the second base member, and pivoting the first upright arm around a first pivot point relative to the first base member and pivoting the second upright arm around a second pivot point relative to the second base member.

21. The method of claim 19, further comprising slideably engaging the cross member with the first upright arm and the second upright arm, pivoting the cross member around a third pivot point relative to the first upright arm, and pivoting the cross member around a fourth pivot point relative to the second upright arm.

22. The method of claim 19, further comprising slideably engaging the mounting bracket with the cross member and pivoting the mounting bracket around a fifth pivot point relative to the cross member in increments.
